(19) United States
(12) Patent Application Publication
(10) Pub. No.: US 2010/0188394 A1
(43) Pub. Date: Jul. 29, 2010

(54) PLASMA DISPLAY PANEL

(75) Inventors: Jeongseob Shim, Gumi (KR); Soonhak Kim, Gumi (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 12/671,465

(22) PCT Filed: Jan. 9, 2009
(86) PCT No.: PCT/KR2009/000120

§ 371 Date: Jan. 29, 2010

(30) Foreign Application Priority Data
Aug. 11, 2008 (KR) 10-2008-0078468

(51) Int. Cl. H01J 17/49; G09G 5/00

(52) U.S. Cl. 345/213; 313/585

(57) ABSTRACT

A plasma display panel is provided. The plasma display panel includes a front substrate, a display electrode on the front substrate, the display electrode including first and second display electrodes adjacent to each other, a rear substrate opposite the front substrate, a barrier rib between the adjacent first and second display electrodes, a black layer opposite the barrier rib, the black layer being positioned substantially parallel to the first and second display electrodes on the front substrate, and an auxiliary electrode on at least one black layer. A shortest distance g1 between the auxiliary electrode and the first display electrode is different from a shortest distance g2 between the auxiliary electrode and the second display electrode.

### TECHNICAL FIELD

Embodiments relate to a plasma display panel.

### BACKGROUND ART

A plasma display panel includes a phosphor layer inside discharge cells partitioned by barrier ribs and a plurality of electrodes.

When driving signals are applied to the electrodes of the plasma display panel, a discharge occurs inside the discharge cells. More specifically, when the discharge occurs in the discharge cells by applying the driving signals to the electrodes, a discharge gas filled in the discharge cells generates vacuum ultraviolet rays, which thereby cause phosphors between the barrier ribs to emit visible light. An image is displayed on the screen of the plasma display panel using the visible light.

### DISCLOSURE OF INVENTION

### Technical Solution

In one aspect, there is a plasma display panel comprising a front substrate, a display electrode on the front substrate, the display electrode including first and second display electrodes adjacent to each other, a rear substrate opposite the front substrate, a barrier rib between the adjacent first and second display electrodes, a black layer opposite the barrier rib, the black layer being positioned substantially parallel to the first and second display electrodes on the front substrate, and an auxiliary electrode on at least one black layer, wherein a shortest distance g1 between the auxiliary electrode and the first display electrode is different from a shortest distance g2 between the auxiliary electrode and the second display electrode.

In another aspect, there is a plasma display panel comprising a front substrate, scan electrodes and sustain electrodes that are positioned on the front substrate substantially parallel to each other, a rear substrate opposite the front substrate, a barrier rib on the rear substrate, a black layer opposite the barrier rib, the black layer being positioned substantially parallel to the scan electrode and the sustain electrode on the front substrate, the black layer including a first black layer between the two adjacent scan electrodes and a second black layer between the two adjacent sustain electrodes, and an auxiliary electrode on the second black layer, wherein when the two adjacent sustain electrodes are called first and second sustain electrodes, a shortest distance between the auxiliary electrode and the first sustain electrode is different from a shortest distance between the auxiliary electrode and the second sustain electrode.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIGS. 1 and 2 illustrate a structure of a plasma display panel according to an exemplary embodiment;

FIG. 3 illustrates an exemplary method of driving a plasma display panel;

FIGS. 4 and 5 illustrate in detail an auxiliary electrode;

FIGS. 6 to 10 illustrate a distance between an auxiliary electrode and a display electrode;

FIGS. 11, 12 and 13 illustrate a ratio of a distance g1 to a distances g2;

FIGS. 14, 15 and 16 illustrate a second black layer;

FIGS. 17 and 18 illustrate a location relationship between first and second black layers and scan and sustain electrodes;

FIGS. 19 to 23 illustrate an arrangement structure of a scan electrode and a sustain electrode;

FIG. 24 illustrates structures of first and second black layers;

FIG. 25 illustrates widths of an auxiliary electrode and a bus electrode;

FIGS. 26 to 28 illustrate an auxiliary electrode and a barrier rib; and

FIG. 29 illustrates a distance between an auxiliary electrode and a scan electrode or a sustain electrode.

### MODE FOR THE INVENTION

Reference will now be made in detail embodiments of the invention examples of which are illustrated in the accompanying drawings.

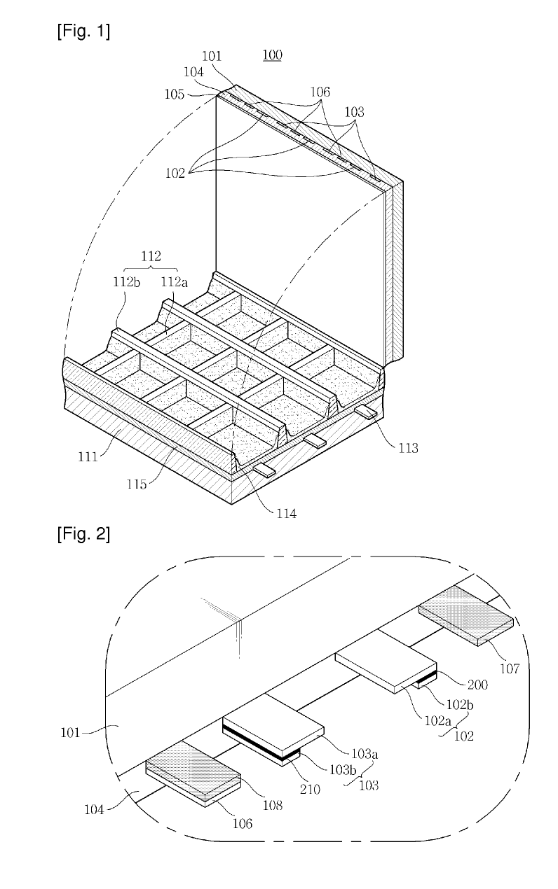

FIGS. 1 and 2 illustrate a structure of a plasma display panel according to an exemplary embodiment.

As shown in FIG. 1, a plasma display panel 100 may include a front substrate 101 on which a plurality of display electrodes 102 and 103 are positioned and a rear substrate 111 on which an address electrode 113 is positioned to cross the display electrodes 102 and 103. The display electrodes 102 and 103 may be a scan electrode 102 and a sustain electrode 103.

An upper dielectric layer 104 may be formed on the scan electrode 102 and the sustain electrode 103 to limit a discharge current of the scan electrode 102 and the sustain electrode 103 and to provide insulation between the scan electrode 102 and the sustain electrode 103.

A protective layer 105 may be formed on the upper dielectric layer 104 to facilitate discharge conditions. The protective layer 105 may be formed of a material having a high secondary electron emission coefficient, for example, magnesium oxide (MgO).

A lower dielectric layer 115 may be formed on the address electrode 113 to provide insulation between the address electrodes 113.

Bather ribs 112 of a stripe type, a well type, a delta type, a honeycomb type, etc. may be formed on the lower dielectric layer 115 to partition discharge spaces (i.e., discharge cells). Hence, a first discharge cell emitting red light, a second discharge cell emitting blue light, and a third discharge cell emitting green light, etc. may be formed between the front substrate 101 and the rear substrate 111.

The bather rib 112 may include first and second bather ribs 112a and 112b crossing each other. Heights of the first and second bather ribs 112a and 112b may be different from each other. The first bather rib 112a may be substantially parallel to the scan electrode 102 and the sustain electrode 103, and the second bather rib 112b may be substantially parallel to the address electrode 113.

The height of the first bather rib 112a may be less than the height of the second bather rib 112b. Hence, in an exhaust process and a process for injecting a discharge gas, an impurity gas in the panel 100 may be efficiently exhausted to the outside of the panel 100, and the discharge gas may be uniformly injected. Each of the discharge cells partitioned by the barrier ribs 112 may be filled with the discharge gas.

A phosphor layer 114 may be formed inside the discharge cells to emit visible light for an image display during an address discharge. For example, first, second, and third phosphor layers that respectively generate red, blue, and green light may be formed inside the discharge cells.

FIG. 1 shows that the upper dielectric layer 104 and the lower dielectric layer 115 each have a single-layered structure. At least one of the upper dielectric layer 104 and the lower dielectric layer 115 may have a multi-layered structure.

While the address electrode 113 may have a substantially constant width or thickness, a width or thickness of the address electrode 113 inside the discharge cell may be different from a width or thickness of the address electrode 113 outside the discharge cell. For example, a width or thickness of the address electrode 113 inside the discharge cell may be greater than a width or thickness of the address electrode 113 outside the discharge cell.

An auxiliary electrode 106 may be positioned on the front substrate 101 substantially parallel to the scan electrode 102 and the sustain electrode 103.

As shown in FIG. 2, first and second black layers 107 and 108 may be positioned parallel to the scan electrode 102 and the sustain electrode 103 on the front substrate 101. The auxiliary electrode 106 may be positioned on the second black layer 108.

The auxiliary electrode 106 may prevent charges from moving between the adjacent discharge cells to contribute to a prevention of crosstalk. The auxiliary electrode 106 may be formed of a material with excellent electrical conductivity, for example, silver (Ag), gold (Au), copper (Cu), aluminum (Al).

The upper dielectric layer 104 may be positioned on the second black layer 108 on which the auxiliary electrode 106 is positioned, the first black layer 107, the scan electrode 102, and the sustain electrode 103.

The scan electrode 102 and the sustain electrode 103 may include transparent electrodes 102a and 103a and bus electrodes 102b and 103b. The transparent electrodes 102a and 103a may be formed of a transparent material, for example, indium-tin-oxide (ITO). The bus electrodes 102b and 103b may be formed of a material with electrical conductivity, such as Ag to improve electrical conductivity of the scan and sustain electrodes 102 and 103. The bus electrodes 102b and 103b may be formed of the same material as the auxiliary electrode 106.

A third black layer 200 may be positioned between the transparent electrode 102a and the bus electrode 102b of the scan electrode 102, and a fourth black layer 210 may be positioned between the transparent electrode 103a and the bus electrode 103b of the sustain electrode 103.

When the first, second, third, and fourth black layers 107, 108, 200, and 210 are positioned as above, a reflection of light coming from the outside may be prevented. Contrast characteristics of a displayed image may be improved.

It may be preferable that a width of the auxiliary electrode 106 may be less than or substantially equal to a width of the second black layer 108, so as to improve the contrast characteristics by preventing light from the outside from being reflected by the auxiliary electrode 106.

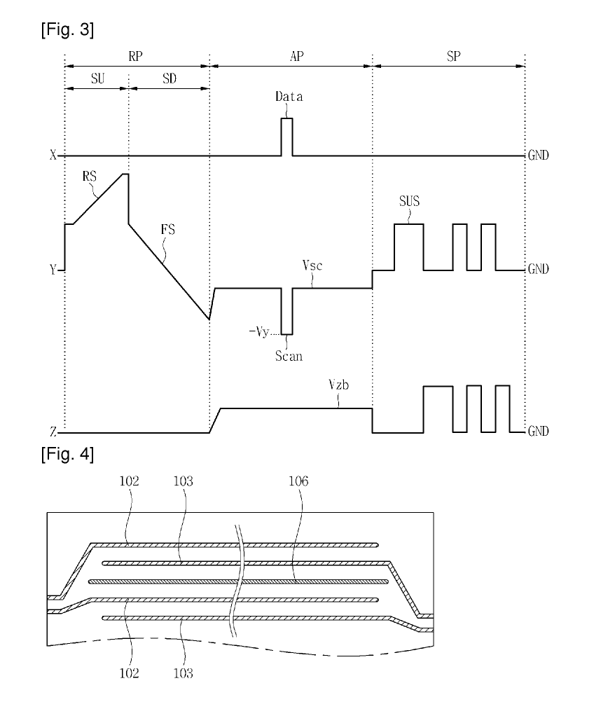

FIG. 3 illustrates an exemplary method of driving the plasma display panel.

As shown in FIG. 3, a rising signal RS and a falling signal FS may be supplied to the scan electrode Y during a reset period RP for initialization of at least one subfield of a plurality of subfields of a frame.

More specifically, the rising signal RS may be supplied to the scan electrode Y during a setup period SU of the reset period RP, and the falling signal FS may be supplied to the scan electrode Y during a set-down period SD following the setup period SU. The rising signal RS may generate a weak dark discharge (i.e., a setup discharge) inside the discharge cells. Hence, the remaining wall charges may be uniformly distributed inside the discharge cells. The falling signal FS may generate a weak erase discharge (i.e., a set-down discharge) inside the discharge cells. Hence, the remaining wall charges may be uniformly distributed inside the discharge cells to the extent that an address discharge occurs stably.

During an address period AP following the reset period RP, a scan bias signal Vsc having a voltage greater than a minimum voltage of the falling signal FS may be supplied to the scan electrode Y. A scan signal Scan falling from the scan bias signal Vsc may be supplied to the scan electrode Y during the address period AP.

A pulse width of a scan signal supplied to the scan electrode during an address period of at least one subfield of a frame may be different from pulse widths of scan signals supplied during address periods of other subfields of the frame. A pulse width of a scan signal in a subfield may be greater than a pulse width of a scan signal in a next subfield. For example, a pulse width of the scan signal may be gradually reduced in the order of 2.6 μs, 2.3 μs, 2.1 μs, 1.9 μs, etc., or may be reduced in the order of 2.6 μs, 2.3 μs, 2.3 μs, 2.1 μs, 1.9 μs, 1.9 μs, etc. in the successively arranged subfields.

When the scan signal Scan is supplied to the scan electrode Y, a data signal Data corresponding to the scan signal Scan may be supplied to the address electrode X. As the voltage difference between the scan signal Scan and the data signal Data is added to a wall voltage resulting from the wall charges produced during the reset period RP, an address discharge may occur inside the discharge cells to which the data signal Data is supplied.

During a sustain period SP following the address period AP, a sustain signal SUS may be supplied to at least one of the scan electrode Y or the sustain electrode Z. FIG. 3 shows that the sustain signals SUS are alternately supplied to the scan electrode Y and the sustain electrode Z. As the wall voltage inside the discharge cells selected by the generation of the address discharge is added to a sustain voltage of the sustain signal SUS, every time the sustain signal SUS is supplied, a sustain discharge (i.e., a display discharge) may occur between the scan electrode Y and the sustain electrode Z.

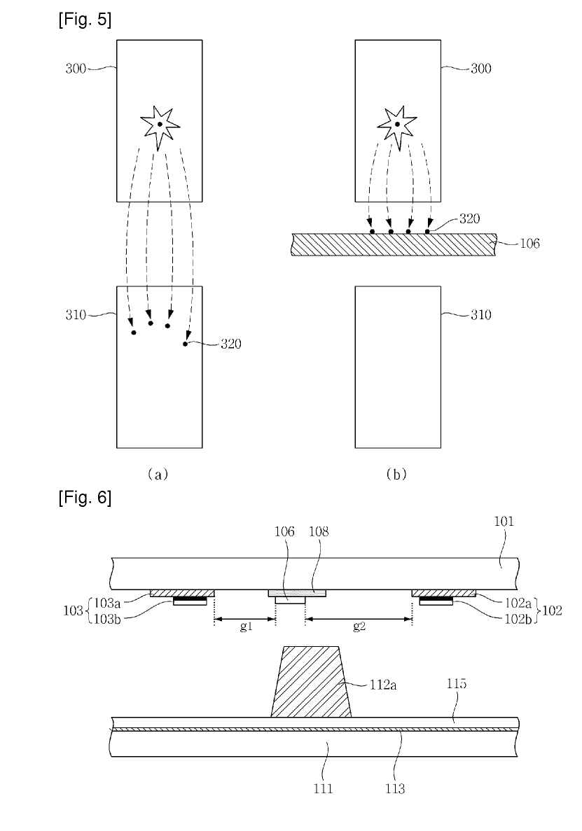

FIGS. 4 and 5 illustrate in detail the auxiliary electrode.

As shown in FIG. 4, both ends of the auxiliary electrode 106 may be positioned inside the panel. In other words, the auxiliary electrode 106 is not electrically connected to an external device and is in a floating state. In this case, a voltage may be produced in the auxiliary electrode 106 because of a coupling phenomenon resulting from a voltage of the scan electrode 102 or the sustain electrode 103 adjacent to the auxiliary electrode 106. Therefore, a voltage of the auxiliary electrode 106 may be determined by the voltage of the scan electrode or the sustain electrode 103 adjacent to the auxiliary electrode 106.

Unlike a description of FIG. 4, a predetermined voltage may be applied to the auxiliary electrode 106. For example, the auxiliary electrode 106 may include a pad portion (not shown) and may be connected to an external ground through the pad portion. Hence, the auxiliary electrode 106 may be held at a ground level voltage. Alternately, the auxiliary electrode 106 may be connected to an external driver through the pad portion and may be held at a positive voltage that is greater than the ground level voltage and less than the sustain voltage of the sustain signal SUS.

As above, the auxiliary electrode 106 may prevent charges from moving between the adjacent discharge cells to contribute to the prevention of crosstalk.

FIG. 5 shows an upper discharge cell 300 called as a first discharge cell and a lower discharge cell 310 called as a second discharge cell. It is assumed that the first discharge cell 300 is an on-cell in which a sustain discharge mars and the second discharge cell 310 is an off-cell in which a sustain discharge does not occur.

If the auxiliary electrode is not formed as shown in (a) of FIG. 5, charges 320 resulting from the sustain discharge generated in the first discharge cell 300 may easily move to the second discharge cell 310 adjacent to the first discharge cell 300. Hence, the charges 320 may generate a sustain discharge in the second discharge cell 310 in which the sustain discharge does not have to occur. The image quality may be reduced because of the crosstalk phenomenon.

On the other hand, if the auxiliary electrode 106 is formed as shown in (b) of FIG. 5, the auxiliary electrode 106 may prevent charges 320 generated in the first discharge cell 300 from moving to the second discharge cell 310. Hence, the crosstalk phenomenon may be prevented.

It may be advantageous in an exhaust process and a process for injecting a discharge gas that the height of the first barrier rib 112a parallel to the scan electrode 102 and the sustain electrode 103 is less than the height of the second barrier rib 112b parallel to the address electrode 113. However, in this case, because charges easily move between the adjacent discharge cells, crosstalk may increase. Accordingly, when the height of the first barrier rib 112a is less than the height of the second barrier rib 112b, it may be preferable that the auxiliary electrode 106 is provided.

FIGS. 6 to 10 illustrate a distance between the auxiliary electrode and the display electrode.

As shown in FIG. 6, distances g1 and g2 between the auxiliary electrode 106 and the display electrodes 102 and 103 may be different from each other. More specifically, when the auxiliary electrode 106 is positioned between the scan and sustain electrodes 102 and 103, the distance g1 between the auxiliary electrode 106 and the sustain electrode 103 may be shorter than the distance g2 between the auxiliary electrode 106 and the scan electrode 102.

As above, when the distances g1 and g2 between the auxiliary electrode 106 and the display electrodes 102 and 103 are different from each other, charges may be prevented from moving in a specific direction. Hence, the crosstalk may be efficiently prevented.

The distances between the auxiliary electrode 106 and the display electrodes 102 and 103 may be distances between the auxiliary electrode 106 and the transparent electrodes 102a and 103a of the display electrodes 102 and 103. It may be preferable that the distances g1 and g2 are determined depending on scan order.

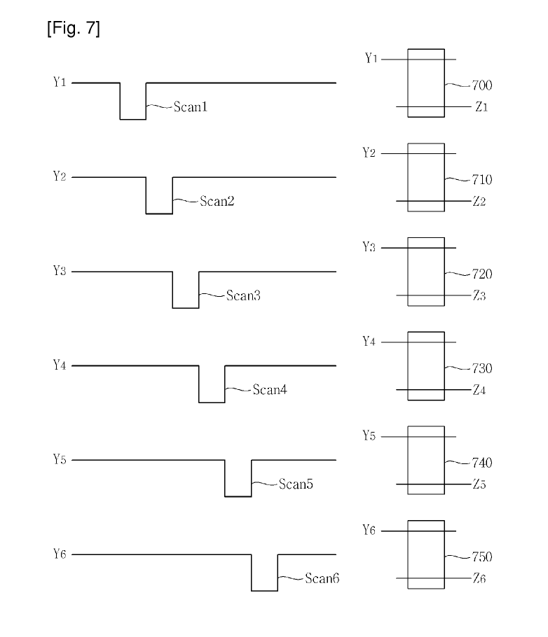

As shown in FIG. 7, when 1st to 6th scan signals Scan 1 to Scan 6 are sequentially supplied to the scan electrodes Y1 to Y6, an address discharge may first occur in a first discharge cell 700 formed by the scan electrode Y1 and the sustain electrode Z1 corresponding to the scan electrode Y1, and then an address discharge may occur in a second discharge cell 710 formed by the scan electrode Y2 and the sustain electrode Z2 corresponding to the scan electrode Y2. Subsequently, address discharges may sequentially occur in 3rd, 4th, 5th, and 6th discharge cells 720, 730, 740, and 750.

In this case, a scan operation in the first discharge cell 700 may be deemed to be performed earlier than a scan operation in the second discharge cell 710. Father, the scan electrode Y1 may be deemed to be scanned earlier than the scan electrode Y2, and the sustain electrode Z1 may be deemed to be scanned earlier than the sustain electrode Z2.

In other words, in an address period of a subfield, a supply time at which the scan signal is supplied to the first discharge cell 700 may be deemed to be earlier than a supply time at which the scan signal is supplied to the second discharge cell 710.

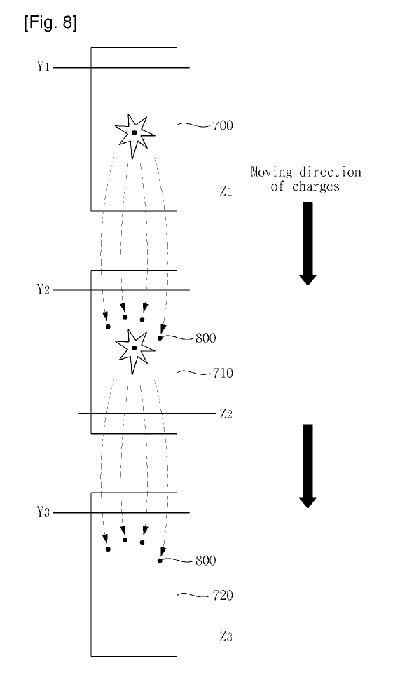

When an address discharge occurs in the first discharge cell 700, charges 800 resulting from the address discharge generated in the first discharge cell 700 may move toward the second discharge cell 710 as shown in FIG. 8. Then, when an address discharge occurs in the second discharge cell 710, charges 800 resulting from the address discharge generated in the second discharge cell 710 may move toward the third discharge cell 720 as shown in FIG. 8.

The charges 800 resulting from the address discharge may move according to scan order. In FIG. 8, a moving direction of the charges 800 is indicated by an arrow.

When the charges 800 move according to scan order as shown in FIG. 8, an erroneous discharge may occur in the discharge cell to which a data signal is not supplied (i.e., the discharge cell in which an address discharge does not have to occur). Namely, a crosstalk phenomenon may be caused.

Of course, the charges 800 may move in a reverse direction (i.e., a reverse direction of scan order) of a direction (i.e., a forward direction of scan order) according to the scan order. However, because the charges 800 moving in the reverse direction enter in the discharge cells in which the address discharge has already occurred, an erroneous discharge does not occur. Further, because the scan signal and the data signal are not supplied to the discharge cells in which the address discharge has already occurred, an erroneous discharge does not occur.

The crosstalk phenomenon, in which the address erroneous discharge occurs by the charges 800 moving in the forward direction of scan order, may be caused.

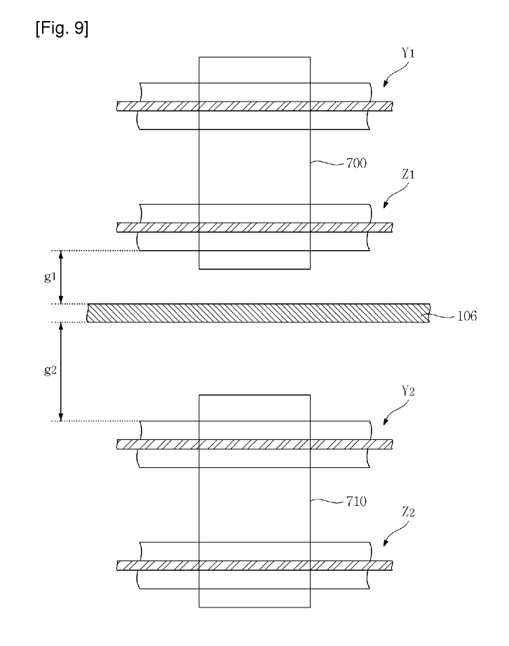

As shown in FIG. 9, the auxiliary electrode 106 may be positioned closer to the first discharge cell 700, whose a scan operation is performed earlier than a scan operation in the second discharge cell 710, than to the second discharge cell 710, so as to prevent the crosstalk phenomenon. More specifically, the auxiliary electrode 106 is positioned close to the sustain electrode Z1 and the scan electrode Y2, and the sustain electrode Z1, the auxiliary electrode 106, and the scan electrode Y2 are positioned in the order named. If the sustain electrode Z1 is scanned earlier than the scan electrode Y2, a distance g1 between the auxiliary electrode 106 and the sustain electrode Z1 may be shorter than a distance g2 between the auxiliary electrode 106 and the scan electrode Y2.

When the distance g1 is shorter than the distance g2, the charges in the first discharge cell 700 may be efficiently prevented from moving to the second discharge cell 710. Hence, the crosstalk phenomenon during the address period may be efficiently prevented.

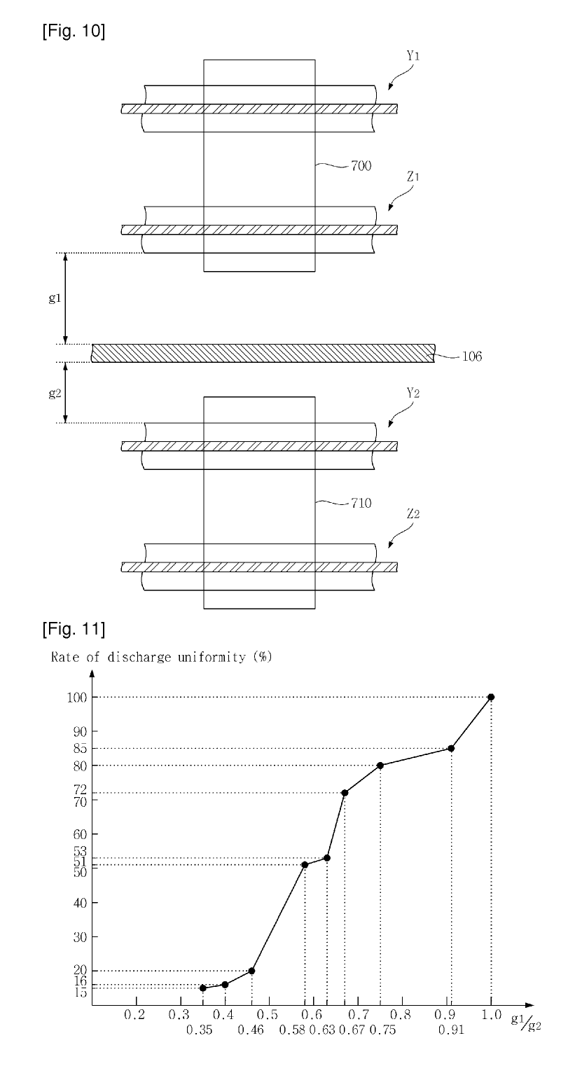

On the other hand, as shown in FIG. 10, when the distance g1 is greater than the distance g2, the charges in the first discharge cell 700 may easily move to the second discharge cell 710. Hence, the address discharge may unstably occur in the second discharge cell 710, and even an erroneous discharge may occur in the second discharge cell 710.

Accordingly, it may be preferable that the auxiliary electrode 106 between two adjacent display electrodes is positioned closer to one of the two adjacent display electrodes, that is scanned earlier than the other display electrode, so as to efficiently prevent the crosstalk resulting from the charges moving in the forward direction of the scan order. Namely, it may be preferable that a distance between the auxiliary electrode 106 and the one display electrode is shorter than a distance between the auxiliary electrode 106 and the other display electrode.

FIGS. 11, 12, and 13 illustrate a ratio g1/g2 of the distance g1 to the distances g2. In FIG. 13, the sustain electrode 103 is scanned, and then the scan electrode 102 is scanned.

FIG. 11 is a graph showing a rate of discharge uniformity when the ratio g1/g2 changes from 0.35 to 1.0. A method for calculating the rate of discharge uniformity is as follows.

When a discharge occurs in test panels manufactured in conformity with the ratio g1/g2, distribution photographs of light resulting from the discharge were taken. It is assumed that the rate of discharge uniformity is 100% when the ratio g1/g2 is 1.0. Subsequently, a large number of experiment participants individually observed light distribution photographs taken when the ratio g1/g2 changes from 0.35 to 0.91, and then determined the rate of discharge uniformity of the light distribution photographs based on the rate of discharge uniformity of 100% assumed when the ratio g1/g2 is 1.0. An average value of the rates of discharge uniformity determined by the experiment participants was found.

In FIG. 11, the fact that the rate of discharge uniformity is a high value means that the discharge uniformly occurs.

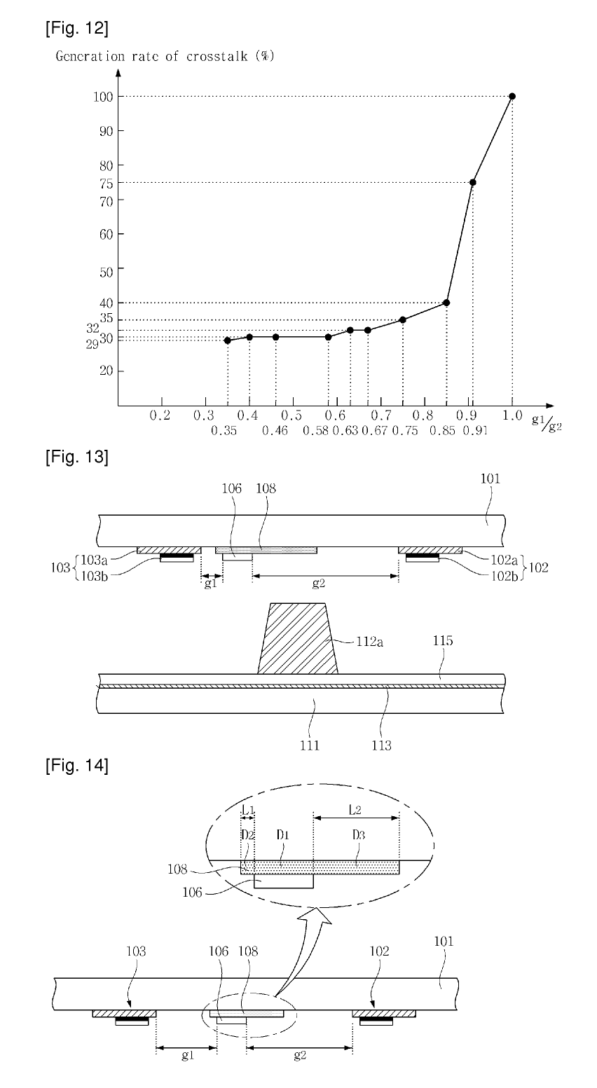

FIG. 12 is a graph showing a generation rate of crosstalk when the ratio g1/g2 changes from 0.35 to 1.0. A method for calculating the generation rate of crosstalk is as follows.

Images with the same pattern were respectively displayed on test panels manufactured in conformity with the ratio g1/g2. The image with the same pattern is an image, whose crosstalk is easy to observe. It is assumed that the generation rate of crosstalk is 100% when the ratio g1/g2 is 1.0.

A large number of experiment participants individually observed the images with the same pattern when the ratio g1/g2 changes from 0.35 to 0.91, and then determined a generation rate of crosstalk of the images based on the generation rate of crosstalk of 100% assumed when the ratio g1/g2 is 1.0. Subsequently, an average value of the generation rates of crosstalk determined by the experiment participants was found. In FIG. 12, as the generation rate of crosstalk becomes lower, a generation possibility of crosstalk becomes lower.

As shown in FIG. 11, when the ratio g1/g2 is 0.35 to 0.46, the rate of discharge uniformity is approximately 15% to 20%. Namely, the value indicates that the discharge uniformity is bad.

In this case, as shown in FIG. 13, the auxiliary electrode 106 may be positioned close to the sustain electrode 103 because of the excessively short distance g1 between the auxiliary electrode 106 and the sustain electrode 103.

Because the auxiliary electrode 106 has electrical conductivity, a discharge starting to occur between the scan electrode 102 and the sustain electrode 103 may be excessively attracted to the auxiliary electrode 106. As a result, light may be non-uniformly generated inside the discharge cells.

In this case, an amount of light emitted to a portion between the sustain electrode 103 and the auxiliary electrode 106 may be more than an amount of light emitted to a portion between the scan electrode 102 and the auxiliary electrode 106. Hence, the image quality may worsen. For example, a viewer may perceive that a luminance sharply varies depending on a direction in which the viewer watches the screen of the panel. Further, the viewer may perceive that the luminance is excessively reduced in a specific direction. Consequently, the viewer may perceive that the image quality of the panel worsens because of the non-uniformity of light.

On the other hand, when the ratio g1/g2 is 0.67 to 0.91, the rate of discharge uniformity is approximately 72% to 85%. Namely, the value indicates that the discharge uniformity is excellent. In this case, the discharge starting to occur between the scan electrode 102 and the sustain electrode 103 may not be excessively attracted in a predetermined direction. Hence, the discharge uniformity may be excellent.

When the ratio g1/g2 is 0.58 to 0.63, the rate of discharge uniformity is approximately 51% to 53%. Namely, the value indicates that the discharge uniformity is good.

As shown in FIG. 12, when the ratio g1/g2 is 0.91, the generation rate of crosstalk is approximately 75%. Namely, the generation possibility of crosstalk is less than the generation possibility of crosstalk when the ratio g1/g2 is 1.

A reason why the generation possibility of crosstalk is reduced as the distance g1 becomes shorter than the distance g2 was described above in detail.

When the ratio g1/g2 is 0.85, the generation rate of crosstalk is approximately 45%. Namely, the generation possibility of crosstalk is greatly reduced. When the ratio g1/g2 is 0.35 to 0.75, the generation rate of crosstalk is approximately 29% to 35%. Namely, the generation possibility of crosstalk is low.

Considering the description of FIGS. 11 and 12, the ratio g1/g2 may be 0.58 to 0.91 or 0.67 to 0.85.

FIGS. 14, 15, and 16 illustrate a second black layer.

As shown in FIG. 14, the second black layer 108 may include first, second, and third portions D1, D2, and D3.

In FIG. 14, the sustain electrode 103 on the left side of the auxiliary electrode 106 is called a first display electrode, the scan electrode 102 on the right side of the auxiliary electrode 106 is called a second display electrode, a distance between the first display electrode 103 and the auxiliary electrode 106 is indicated as g1, and a distance between the second display electrode 102 and the auxiliary electrode 106 is indicated as g2. In this case, the second portion D2 of the second black layer 108 projects toward the first display electrode 103, and the third portion D3 of the second black layer 108 projects toward the second display electrode 102. The first portion D1 of the second black layer 108 overlaps the auxiliary electrode 106.

A width L2 of the third portion D3 may be greater than a width L1 of the second portion D2. In this case, even if the distance g1 is shorter than the distance g2, a reflection of light from the outside may be suppressed, and thus a reduction in the contrast characteristics may be prevented.

Further, when the width L2 of the third portion D3 is greater than the width L1 of the second portion D2, the distance g1 may be shorter than the distance g2 even if a distance L10 between the first display electrode 103 and the second black layer 108 is substantially equal to a distance L20 between the second display electrode 102 and the second black layer 108.

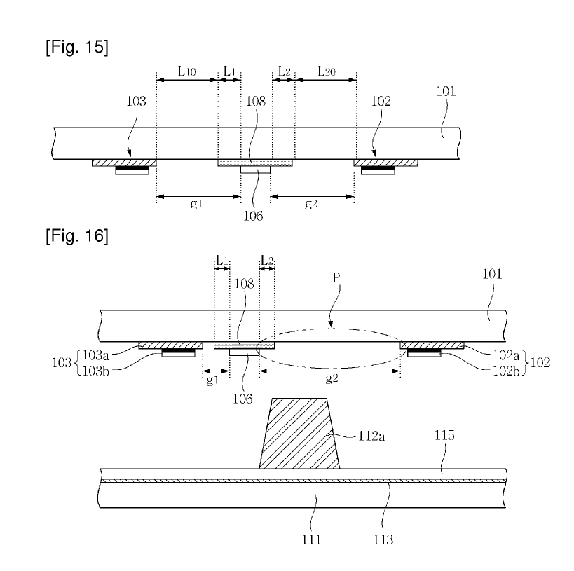

As shown in FIG. 15, when the distance L10 between the first display electrode 103 and the second black layer 108 is substantially equal to the distance L20 between the second display electrode 102 and the second black layer 108 and the width L2 of the third portion D3 is substantially equal to the width L1 of the second portion D2, the distance g1 may be substantially equal to the distance g2. Therefore, it may be difficult to obtain a reduction effect of the crosstalk.

As shown in FIG. 16, when the distance g1 is shorter than the distance g2 in a state where the width L2 of the third portion D3 is substantially equal to the width L1 of the second portion D2, an area between the second display electrode 102 and the auxiliary electrode 106, that are spaced apart from each other at the distance g2, may excessively increases. Hence, light from the outside may be reflected by the first barrier rib 112a, and thus the contrast characteristics may worsen.

On the other hand, when the width L2 of the third portion D3 is greater than the width L1 of the second portion D2 as shown in FIG. 14, the third portion D3 may cover an area between the second display electrode 102 and the auxiliary electrode 106 even if the distance g1 is shorter than the distance g2. Hence, light from the outside may be prevented from being reflected by the first barrier rib 112a, and thus a reduction in the contrast characteristics may prevented.

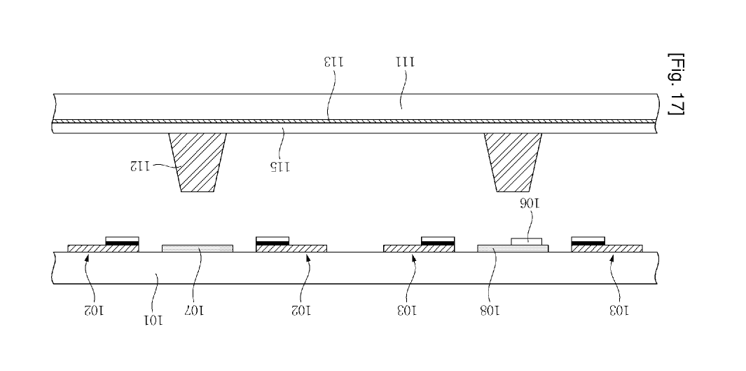

FIGS. 17 and 18 illustrate a location relationship between the first and second black layers and the scan and sustain electrodes.

As shown in FIG. 17, the first and second black layers 107 and 108 are positioned parallel to each other on the front substrate 101 with at least one scan electrode 102 and at least one sustain electrode 103 interposed between the first and second black layers 107 and 108. the first black layer and the second black layer 107 and 108 are positioned alternately.

The first and second black layers 107 and 108 may be spaced apart from the scan and sustain electrodes 102 and 103 adjacent to the first and second black layers 107 and 108. Alternately, as shown in FIG. 18, the first and second black layers 107 and 108 may be connected to the two adjacent scan electrodes 102 and the two adjacent sustain electrodes 103, respectively. In this case, the first black layer 107 and the fourth black layers 210 of the two adjacent scan electrode 102 may form one common black layer, and the second black layer 108 and the fourth black layers 210 of the two adjacent sustain electrodes 103 may form one common black layer.

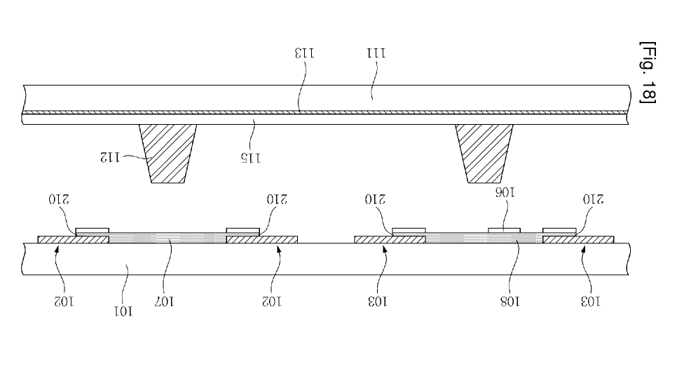

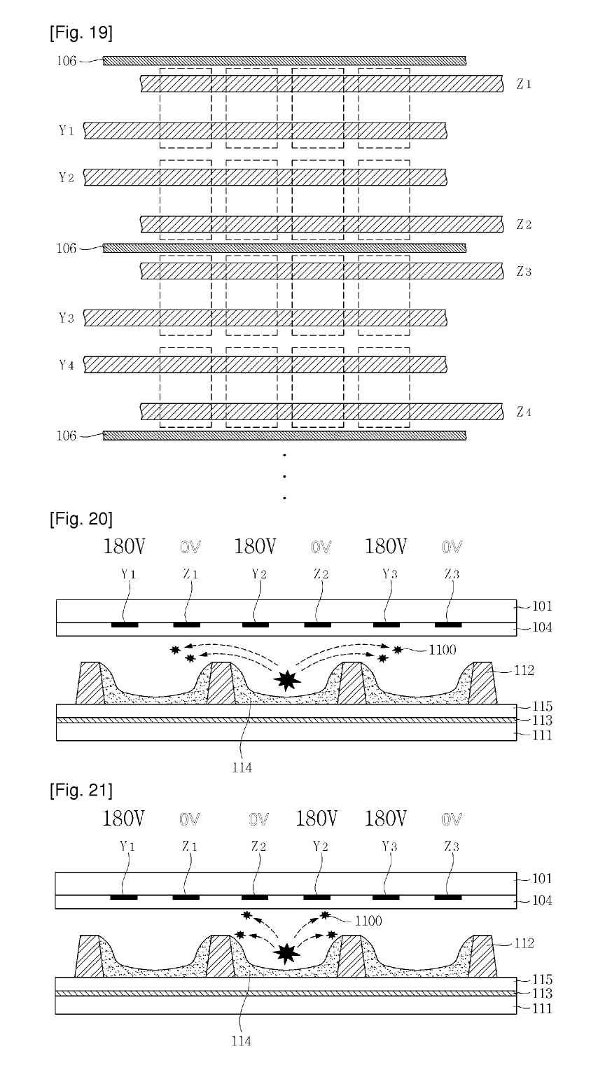

FIGS. 19 to 23 illustrate an arrangement structure of the scan electrode and the sustain electrode. The illustration of the first and second black layers is omitted in FIGS. 19 to 23.

The two scan electrodes may be adjacently positioned, and the two sustain electrodes may be adjacently positioned. For example, FIG. 19 shows two adjacent scan electrodes Y1 and Y2, two adjacent scan electrodes Y3 and Y4, and two adjacent sustain electrodes Z2 and Z3.

In the above electrode arrangement, it may be preferable that the auxiliary electrode 106 is positioned between the two adjacent sustain electrodes. Namely, the second black layer is positioned between the two adjacent sustain electrodes, and the auxiliary electrode 106 is positioned on the second black layer.

In the above electrode arrangement, the drive efficiency may be improved by reducing a capacitance between the two adjacent scan electrodes and a capacitance between the two adjacent sustain electrodes. Father, the crosstalk may be reduced by reducing a voltage difference between the two adjacent scan electrodes and a voltage difference between the two adjacent sustain electrodes during a discharge.

FIG. 20 shows that the scan electrodes Y1, Y2, and Y3 and the sustain electrodes Z1, Z2, and Z3 are alternately positioned. In FIG. 20, it is assumed that sustain signals having a voltage of 180V are supplied to the scan electrodes Y1, Y2, and Y3 and 0V is supplied to the sustain electrodes Z1, Z2, and Z3.

In this case, a movement of charges 1100 between the adjacent discharge cells may briskly occurs. For example, if a sustain discharge occurs between the scan electrode Y2 and the sustain electrode Z2 as shown in FIG. 20, a voltage difference of 180V is caused between the sustain electrode Z2 and the scan electrode Y3 and between the scan electrode Y2 and the sustain electrode Z1. The charges 1100 resulting from the sustain discharge generated between the scan electrode Y2 and the sustain electrode Z2 are attracted to the scan electrode Y3 or the sustain electrode Z1 and move to the discharge cell adjacent to the discharge cell where the sustain discharge occurs. As a result, a sustain discharge may occur between the scan electrode Y1 and the sustain electrode Z1 or between the scan electrode Y3 and the sustain electrode Z3. Namely, the crosstalk phenomenon may frequently occur.

On the other hand, as shown in FIG. 21, when two scan electrodes are adjacently positioned and two sustain electrodes are adjacently positioned, a voltage difference of 0V is caused between the sustain electrodes Z1 and Z2 and the scan electrodes Y2 and Y3 even if sustain signals having a voltage of 180V are supplied to the scan electrodes and 0V is supplied to the sustain electrodes. Because a voltage difference is not caused between the adjacent discharge cells, a movement of charges 1100 is suppressed. Hence, the crosstalk may be reduced.

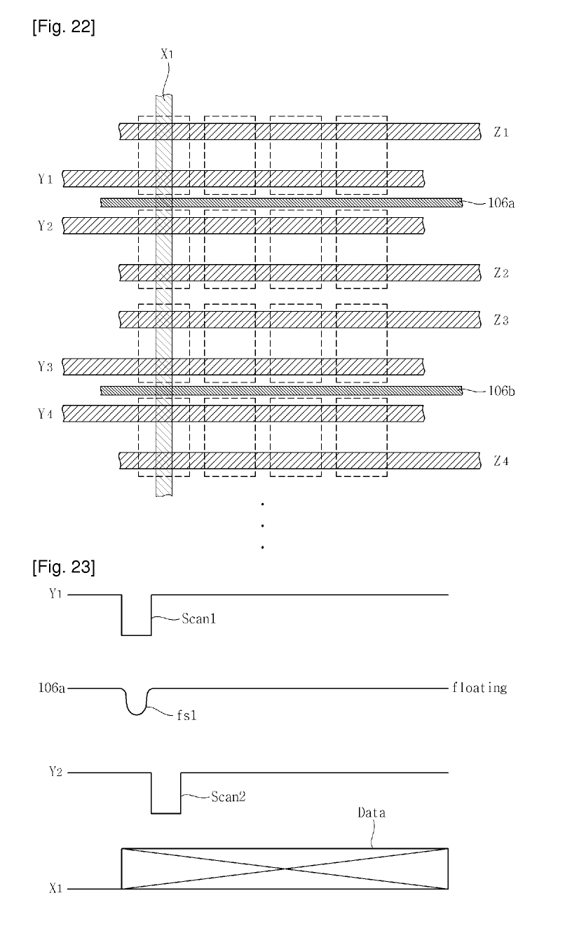

A reason why the auxiliary electrode 106 is positioned between the two adjacent sustain electrodes will be described with reference to FIGS. 22 and 23.

FIG. 22 shows that the auxiliary electrode is positioned between the two adjacent scan electrodes. More specifically, a first auxiliary electrode 106a is positioned between the two scan electrodes Y1 and Y2, and a second auxiliary electrode 106b is positioned between the two scan electrodes Y3 and Y4.

FIG. 23 illustrates an exemplary operation of the panel during an address period in the electrode structure shown in FIG. 22. The first and second auxiliary electrodes 106a and 106b are considered to be floated.

For example, when a first scan signal Scan 1 is supplied to the scan electrode Y1, an address discharge may occur by a voltage difference between a data signal supplied to the address electrode X1 and the first scan signal Scan 1. Further, when a second scan signal Scan 2 is supplied to the scan electrode Y2, an address discharge may mar by a voltage difference between the data signal supplied to the address electrode X1 and the second scan signal Scan 2.

When the address discharge occurs by the first scan signal Scan 1 and the data signal, a first falling signal fs1 may be produced in the first auxiliary electrode 106a by a voltage of the first scan signal Scan 1. A voltage of the first falling signal fs1 affects the scan electrode Y2 adjacent to the first auxiliary electrode 106a, and thus a distribution state of wall charges on the scan electrode Y2 may be non-uniform. Hence, the address discharge generated by the second scan signal Scan 2 and the data signal may be unstable. When the voltage of the first falling signal fs1 has a excessively great value, an erroneous discharge may occur between the scan electrode Y2 or the first auxiliary electrode 106a and the address electrode when the address discharge occurs by the first scan signal Scan 1 and the data signal.

As above, when the auxiliary electrode is positioned between two scan electrodes, the address discharge may unstably occur or the erroneous discharge may occur. Therefore, it is preferable that the auxiliary electrode is positioned between two sustain electrodes as shown in FIG. 19.

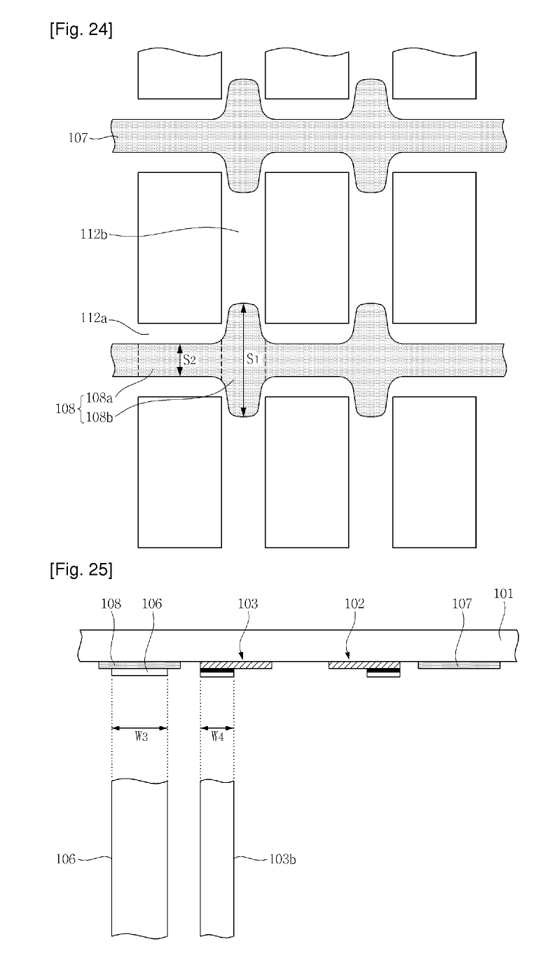

FIG. 24 illustrates structures of the first and second black layers.

At least one of the first and second black layers 107 and 108 may include first and second portions each having a different width. For example, FIG. 24 shows that the first and second black layers 107 and 108 each include a 10th portion having a first width S1 and a 20th portion having a first width S2.

Because the second black layer 108 includes the 10th portion 108a and the 20th portion 108b as shown in FIG. 24, the auxiliary electrode (not shown) on the second black layer 108 may include 10th and 20th portions each having a different width.

The second portions of the first and second black layers 107 and 108 may be positioned at a crossing of the first and second barrier ribs 112a and 112b.

As above, when at least one of the first and second black layers 107 and 108 includes the 10th and 20th portions, a black area may increase. Hence, the contrast characteristics may be improved. Further, when the second portions of the first and second black layers 107 and 108 is positioned at the crossing of the first and second barrier ribs 112a and 112b, a black area may increase while a reduction in an aperture ratio is prevented. Hence, the contrast characteristics may be further improved.

FIG. 25 illustrates widths of the auxiliary electrode and the bus electrode.

As shown in FIG. 25, a width W3 of the auxiliary electrode 106 may be greater than a width W4 of the bus electrode 103b. The width W3 of the auxiliary electrode 106 may be greater than a width of the bus electrode of the scan electrode 102 as well as the bus electrode 103b of the sustain electrode 103.

As above, when the width W3 of the auxiliary electrode 106 is greater than the width W4 of the bus electrode 103b, a charge capacity of the auxiliary electrode 106 may sufficiently increase. Therefore, charge may be prevented from moving between the adjacent discharge cells, and the crosstalk may be reduced.

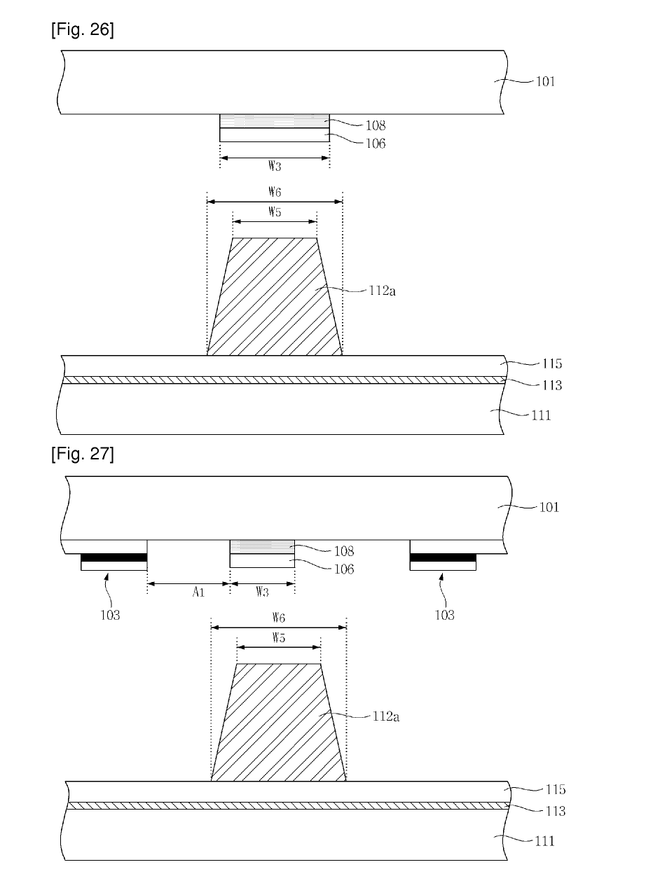

FIGS. 26 to 28 illustrate an auxiliary electrode and a barrier rib. As shown in FIG. 26, the width W3 of the auxiliary electrode 106 may be greater than an upper width W5 of the first bather rib 112a and less than a lower width W6 of the first barrier rib 112a. Father, the width W3 of the auxiliary electrode 106 may be substantially equal to the upper width W5 or the lower width W6 of the first bather rib 112a.

When the width W3 of the auxiliary electrode 106 is greater than or equal to the upper width W5 of the first bather rib 112a and is less than or equal to the lower width W6 of the first barrier rib 112a, electrical short circuit between the auxiliary electrode 106 and the scan electrode 102 or the sustain electrode 103 adjacent to the auxiliary electrode 106 may be prevented while charge are prevented from moving between the adjacent discharge cells.

As shown in FIG. 27, when the width W3 of the auxiliary electrode 106 is less than the ripper width W5 of the first bather rib 112a, the charge capacity of the auxiliary electrode 106 may be reduced because of the narrow auxiliary electrode 106. Hence, it may be difficult to prevent the crosstalk. Further, a distance A1 between the auxiliary electrode 106 and the scan electrode 102 or the sustain electrode 103 adjacent to the auxiliary electrode 106 may excessively increase. Hence, an amount of light reflected by the first bather rib 112a may increase, and the contrast characteristics may be reduced.

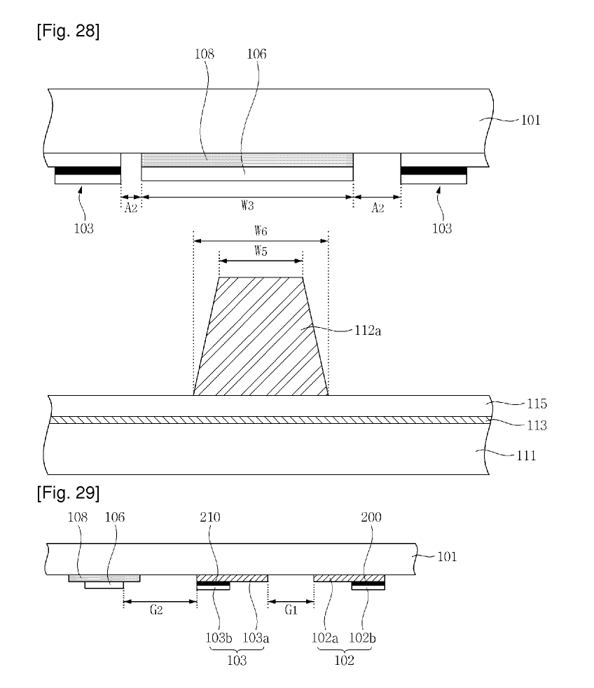

As shown in FIG. 28, when the width W3 of the auxiliary electrode 106 is greater than the lower width W6 of the first barrier rib 112a, a distance A2 between the auxiliary electrode 106 and the scan electrode 102 or the sustain electrode 103 adjacent to the auxiliary electrode 106 may excessively decrease because of the wide auxiliary electrode 106. In this case, electrical short circuit may occur between the auxiliary electrode 106 and the scan electrode 102 or the sustain electrode 103 adjacent to the auxiliary electrode 106, thereby unstably generating a discharge.

Considering this, it may be preferable that the width W3 of the auxiliary electrode 106 is greater than or equal to the upper width W5 of the first barrier rib 112a and is less than or equal to the lower width W6 of the first barrier rib 112a.

FIG. 29 illustrates a distance between an auxiliary electrode and a scan electrode or a sustain electrode.

As shown in FIG. 29, a distance G2 between the auxiliary electrode 106 and the scan electrode 102 or the sustain electrode 103 may be greater than a distance G1 between the scan electrode 102 and the sustain electrode 103. In this case, a firing voltage between the scan electrode 102 and the sustain electrode 103 may be prevented from excessively rising, and a reduction in the drive efficiency may be prevented. Further, a discharge generated between the scan electrode 102 and the sustain electrode 103 may be prevented from being excessively attracted to the auxiliary electrode 106.

Any reference in this specification to one embodiment, an embodiment, example embodiment, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A plasma display panel comprising:
a front substrate;
a display electrode on the front substrate, the display electrode including first and second display electrodes adjacent to each other;
a rear substrate opposite the front substrate;
a barrier rib between the adjacent first and second display electrodes;
a black layer opposite the barrier rib, the black layer being positioned substantially parallel to the first and second display electrodes on the front substrate; and
an auxiliary electrode on at least one black layer,
wherein a shortest distance g1 between the auxiliary electrode and the first display electrode is different from a shortest distance g2 between the auxiliary electrode and the second display electrode.

2. A plasma display panel of claim 1, wherein the black layer includes a first black layer on which the auxiliary electrode is not positioned and a second black layer on which the auxiliary electrode is positioned.

3. A plasma display panel of claim 2, wherein the first black layer and the second black layer are positioned alternately.

4. A plasma display panel of claim 1, wherein the display electrode includes a transparent electrode and a bus electrode on the transparent electrode, and a distance between the auxiliary electrode and the display electrode is a distance between the auxiliary electrode and the transparent electrode.

5. A plasma display panel of claim 1, wherein the first display electrode in a first discharge cell is scanned earlier than the second display electrode in a second discharge cell,
wherein the distance g1 is shorter than the distance g2.

6. A plasma display panel of claim 5, wherein a supply time at which a scan signal is supplied to the first discharge cell is earlier than a supply time at which a scan signal is supplied to the second discharge cell.

7. A plasma display panel of claim 5, wherein a ratio of the distance g1 to the distance g2 is substantially 0.58 to 0.91.

8. A plasma display panel of claim 5, wherein a second black layer includes a first portion overlapping the auxiliary electrode, a second portion projecting toward the first display electrode, and a third portion projecting toward the second display electrode,
wherein a width of the second portion is less than a width of the third portion.

9. A plasma display panel comprising:
a front substrate;
scan electrodes and sustain electrodes that are positioned substantially parallel to each other on the front substrate;
a rear substrate opposite the front substrate;
a barrier rib on the rear substrate;
a black layer opposite the barrier rib, the black layer being positioned substantially parallel to the scan electrode and the sustain electrode on the front substrate, the black layer including a first black layer between two adjacent scan electrodes and a second black layer between two adjacent sustain electrodes; and
an auxiliary electrode on the second black layer,
wherein the two adjacent sustain electrodes include first and second sustain electrodes, and wherein a shortest distance between the auxiliary electrode and the first sustain electrode is different from a shortest distance between the auxiliary electrode and the second sustain electrode.

10. A plasma display panel of claim 9, wherein the sustain electrode includes a transparent electrode and a bus electrode on the transparent electrode, and a distance between the auxiliary electrode and the sustain electrode is a distance between the auxiliary electrode and the transparent electrode of the sustain electrode.

11. A plasma display panel of claim 9, wherein a first auxiliary electrode belonging to the auxiliary electrode is adjacent to the first and second sustain electrodes,
wherein the first sustain electrode is scanned earlier than the second sustain electrode,
wherein a distance g1 between the first auxiliary electrode and the first sustain electrode is shorter than a distance g2 between the first auxiliary electrode and the second sustain electrode.

12. A plasma display panel of claim 11, wherein in an address period of a subfield, a supply time at which a scan signal is supplied to a first scan electrode corresponding to the first sustain electrode is earlier than a supply time at which a scan signal is supplied to a second scan electrode corresponding to the second sustain electrode.

13. A plasma display panel of claim 11, wherein a ratio of the distance g1 to the distance g2 is substantially 0.58 to 0.91.

14. A plasma display panel of claim 11, wherein the second black layer includes a first portion overlapping the first auxiliary electrode, a second portion projecting toward the first sustain electrode, and a third portion projecting toward the second sustain electrode,
wherein a width of the second portion is less than a width of the third portion.

15. A plasma display panel of claim 9, wherein a width of the auxiliary electrode is less than or equal to a width of the second black layer.

16. A plasma display panel of claim 9, wherein the barrier rib includes a first barrier rib substantially parallel to the scan electrode and the sustain electrode and a second barrier rib crossing the first barrier rib,
wherein a width of the auxiliary electrode is greater than or equal to an upper width of the first barrier rib and is less than or equal to a lower width of the first barrier rib.

17. A plasma display panel of claim 9, wherein the scan electrode and the sustain electrode each include a transparent electrode and a bus electrode on the transparent electrode,
wherein a width of the auxiliary electrode is greater than or equal to a width of the bus electrode.

18. A plasma display panel of claim 9, wherein the auxiliary electrode is floated.

19. A plasma display panel of claim 9, wherein the bather rib includes a first bather rib substantially parallel to the scan electrode and the sustain electrode and a second bather rib crossing the first bather rib,
wherein a height of the first barrier rib is less than a height of the second bather rib.

20. A plasma display panel of claim 9, wherein a shortest distance between the auxiliary electrode and the sustain electrode is greater than a shortest distance between the scan electrode and the sustain electrode.
